(19) United States
(12) Patent Application Publication
(10) Pub. No.: US 2023/0309117 A1
(43) Pub. Date: Sep. 28, 2023

(54) SIDELINK FEEDBACK CHANNEL RESOURCE MAPPING IN UNLICENSED SPECTRUM

(71) Applicant: QUALCOMM Incorporated, San Diego, CA (US)

(72) Inventors: Jing SUN, San Diego, CA (US); Ozcan OZTURK, San Diego, CA (US); Juan MONTOJO, San Diego, CA (US); Tao LUO, San Diego, CA (US); Xiaoxia ZHANG, San Diego, CA (US); Peter GAAL, San Diego, CA (US); Changlong XU, Beijing (CN)

(21) Appl. No.: 18/041,049

(22) PCT Filed: Oct. 9, 2020
(86) PCT No.: PCT/CN2020/119938

§ 371 Date: Feb. 8, 2023

(51) Int. Cl. H04W 72/25; H04W 16/14

(52) U.S. Cl. CPC H04W 72/25; H04W 16/14

(57) ABSTRACT

Certain aspects of the present disclosure provide techniques for communicating using sidelink resources allocated in an unlicensed spectrum. A method that may be performed by a first UE includes receiving one or more transmissions from a second UE on one or more sidelink sub-channels spanning one or more resource block (RB) sets of an unlicensed spectrum occupied by the second UE for a channel occupancy time (COT) and transmitting, to the second UE, feedback information corresponding to the one or more received transmissions on a feedback channel based on a mapping between the one or more sidelink sub-channels and the feedback channel that confines the feedback channel to at least the one or more RB sets and one or more guard bands between the one or more RB sets of the unlicensed spectrum occupied by the second UE for the COT.

### INTRODUCTION

Aspects of the present disclosure relate to wireless communications, and more particularly, to techniques for sidelink feedback channel resource mapping in unlicensed spectrum.

Wireless communication systems are widely deployed to provide various telecommunication services such as telephony, video, data, messaging, broadcasts, etc. These wireless communication systems may employ multiple-access technologies capable of supporting communication with multiple users by sharing available system resources (e.g., bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

These multiple access technologies have been adopted in various telecommunication standards to provide a common protocol that enables different wireless devices to communicate on a municipal, national, regional, and even global level. New radio (e.g., 5G NR) is an example of an emerging telecommunication standard. NR is a set of enhancements to the LTE mobile standard promulgated by 3GPP. NR is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL). To these ends, NR supports beamforming, multiple-input multiple-output (MIMO) antenna technology, and carrier aggregation.

However, as the demand for mobile broadband access continues to increase, there exists a need for further improvements in NR and LTE technology. Preferably, these improvements should be applicable to other multi-access technologies and the telecommunication standards that employ these technologies.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improvements to sidelink feedback channel resource mapping in unlicensed spectrum.

Certain aspects of the subject matter described in this disclosure can be implemented in a method for wireless communication by a first user equipment (UE). The method generally includes receiving one or more transmissions from a second UE on one or more sidelink sub-channels spanning one or more resource block (RB) sets of an unlicensed spectrum occupied by the second UE for a channel occupancy time (COT) and transmitting, to the second UE, feedback information corresponding to the one or more received transmissions on a feedback channel based on a mapping between the one or more sidelink sub-channels and the feedback channel that confines the feedback channel to at least the one or more RB sets and one or more guard bands between the one or more RB sets of the unlicensed spectrum occupied by the second UE for the COT.

Certain aspects of the subject matter described in this disclosure can be implemented in a first user equipment (UE) for wireless communication by a first user equipment (UE). The first UE generally includes means for receiving one or more transmissions from a second UE on one or more sidelink sub-channels spanning one or more resource block (RB) sets of an unlicensed spectrum occupied by the second UE for a channel occupancy time (COT) and means for transmitting, to the second UE, feedback information corresponding to the one or more received transmissions on a feedback channel based on a mapping between the one or more sidelink sub-channels and the feedback channel that confines the feedback channel to at least the one or more RB sets and one or more guard bands between the one or more RB sets of the unlicensed spectrum occupied by the second UE for the COT.

Certain aspects of the subject matter described in this disclosure can be implemented in a first user equipment (UE) for wireless communication. The first UE generally includes a memory; and a processor coupled to the memory, the memory and the processor configured to: receive one or more transmissions from a second UE on one or more sidelink sub-channels spanning one or more resource block (RB) sets of an unlicensed spectrum occupied by the second UE for a channel occupancy time (COT) and transmit, to the second UE, feedback information corresponding to the one or more received transmissions on a feedback channel based on a mapping between the one or more sidelink sub-channels and the feedback channel that confines the feedback channel to at least the one or more RB sets and one or more guard bands between the one or more RB sets of the unlicensed spectrum occupied by the second UE for the COT.

Certain aspects of the subject matter described in this disclosure can be implemented in a computer-readable medium for wireless communication. The medium including instructions that, when executed by at least one processor of a first user equipment (UE), cause the at least one processor to receive one or more transmissions from a second UE on one or more sidelink sub-channels spanning one or more resource block (RB) sets of an unlicensed spectrum occupied by the second UE for a channel occupancy time (COT) and transmit, to the second UE, feedback information corresponding to the one or more received transmissions on a feedback channel based on a mapping between the one or more sidelink sub-channels and the feedback channel that confines the feedback channel to at least the one or more RB sets and one or more guard bands between the one or more RB sets of the unlicensed spectrum occupied by the second UE for the COT.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example wireless communication network, in accordance with certain aspects of the present disclosure.

FIG. 2 is a block diagram conceptually illustrating a design of an example a base station (BS) and user equipment (UE), in accordance with certain aspects of the present disclosure.

FIG. 3 is an example frame format for certain wireless communication systems (e.g., new radio (NR)), in accordance with certain aspects of the present disclosure.

FIG. 4A and FIG. 4B show diagrammatic representations of example vehicle to everything (V2X) systems, in accordance with certain aspects of the present disclosure.

FIG. 5 shows a time-frequency grid illustrating example resource pools for sidelink communication, in accordance with certain aspects of the present disclosure.

FIG. 6 illustrates an example sidelink feedback channel resource pool mapping, in accordance with certain aspects of the present disclosure.

FIG. 7 illustrates an example resource allocation in an unlicensed spectrum, in accordance with certain aspects of the present disclosure.

FIG. 8 illustrates an example mapping between one or more sidelink sub-channels and a sidelink feedback channel, in accordance with certain aspects of the present disclosure.

FIG. 9 illustrates an example sidelink feedback channel resource mapping based on resources allocated to a sidelink shared channel, in accordance with certain aspects of the present disclosure.

FIG. 10 illustrates another example sidelink feedback channel resource mapping based on resources allocated to a sidelink shared channel, in accordance with certain aspects of the present disclosure.

FIG. 11 illustrates an example sidelink feedback channel resource pool definition, in accordance with certain aspects of the present disclosure.

FIG. 12 illustrates another example sidelink feedback channel resource pool definition, in accordance with certain aspects of the present disclosure.

FIG. 13 illustrates an example dynamic sidelink feedback channel resource pool definition, in accordance with certain aspects of the present disclosure.

FIG. 14 illustrates an example dynamic sidelink feedback channel resource pool definition based on resources allocated to a sidelink shared channel, in accordance with certain aspects of the present disclosure.

FIG. 15 illustrates an example dynamic sidelink feedback channel resource pool definition based on resources allocated to a sidelink control channel, in accordance with certain aspects of the present disclosure.

FIG. 16 is a flow diagram illustrating example operations for wireless communication by a UE, in accordance with certain aspects of the present disclosure.

FIG. 17 illustrates a communications device that may include various components configured to perform operations for the techniques disclosed herein in accordance with aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, methods, processing systems, and computer readable mediums for sidelink feedback channel resource mapping in unlicensed spectrum. In particular, certain aspects relate to mapping one or more sidelink sub-channels to a given sidelink feedback channel so as to confine the sidelink feedback channel to resource block (RB) sets spanned by the sidelink sub-channels.

In certain aspects, RBs may be assigned to sets (e.g., subbands), where each RB set includes a plurality of RBs. Further, a guard band (e.g., intra-cell guard band) may be defined between each of the RB sets. In certain aspects, sub-channels are mapped to and span one or more RB sets, and sometimes even the guard band between RB sets. A UE, to utilize a particular sub-channel, may perform a listen-before-talk (LBT) procedure on the one or more RB sets spanned by the sub-channel, whereby the UE measures whether an energy level on the one or more RB sets is below a threshold. If the UE successfully determines the energy level of the one or more RB sets is below the threshold, it may begin transmitting on the particular sub-channel, thereby reserving the one or more RB sets for a period of time referred to as a channel occupancy time (COT).

In certain aspects, a UE receiving transmissions is configured to provide feedback on a feedback channel, such as whether the transmission is successfully received and decoded such as by sending an acknowledgement (ACK) or whether the transmission is not successfully decoded, such as by sending a negative ACK (NACK). In order to do so in the unlicensed spectrum, the UE would normally need to perform a LBT procedure to make sure resources are available to send ACK/NACK. However, in certain aspects, the UE transmitting the transmissions to the receiving UE can share its reservation of resources during the COT so the receiving UE can transmit the feedback without performing a LBT procedure. Accordingly, certain aspects herein relate to mapping a feedback channel for providing feedback to transmissions made in a sub-channel to the RB set(s) (and optionally guard band(s)) spanned by the sub-channel that are reserved during the COT.

The following description provides examples of communicating using sidelink resources allocated in unlicensed spectrum in communication systems, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method which is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs.

The techniques described herein may be used for various wireless networks and radio technologies. While aspects may be described herein using terminology commonly associated with 3G, 4G, and/or new radio (e.g., 5G NR) wireless technologies, aspects of the present disclosure can be applied in other generation-based communication systems.

NR access may support various wireless communication services, such as enhanced mobile broadband (eMBB) targeting wide bandwidth (e.g., 80 MHz or beyond), millimeter wave (mmW) targeting high carrier frequency (e.g., e.g., 24 GHz to 53 GHz or beyond), massive machine type communications MTC (mMTC) targeting non-backward compatible MTC techniques, and/or mission critical targeting ultra-reliable low-latency communications (URLLC). These services may include latency and reliability requirements. These services may also have different transmission time intervals (TTI) to meet respective quality of service (QoS) requirements. In addition, these services may co-exist in the same subframe. NR supports beamforming and beam direction may be dynamically configured. MIMO transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells.

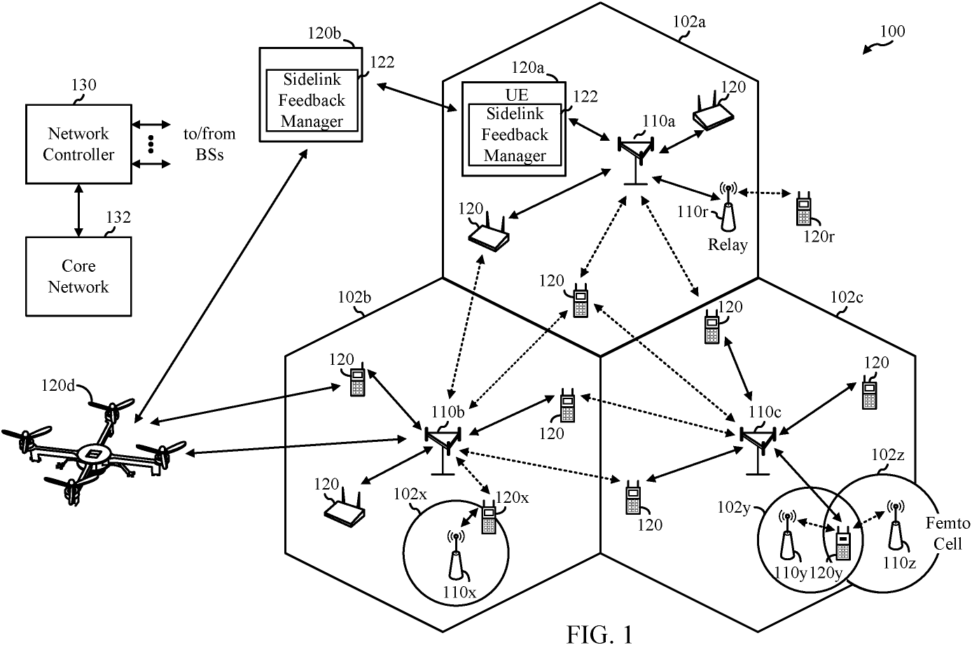

FIG. 1 illustrates an example wireless communication network 100 in which aspects of the present disclosure may be performed. For example, the wireless communication network 100 may be an NR system (e.g., a 5G NR network). As shown in FIG. 1, the wireless communication network 100 may be in communication with a core network 132. The core network 132 may in communication with one or more base station (BSs) 110 and/or user equipment (UE) 120 in the wireless communication network 100 via one or more interfaces.

As illustrated in FIG. 1, the wireless communication network 100 may include a number of BSs 110a-z (each also individually referred to herein as BS 110 or collectively as BSs 110) and other network entities. A BS 110 may provide communication coverage for a particular geographic area, sometimes referred to as a “cell”, which may be stationary or may move according to the location of a mobile BS 110. In some examples, the BSs 110 may be interconnected to one another and/or to one or more other BSs or network nodes (not shown) in wireless communication network 100 through various types of backhaul interfaces (e.g., a direct physical connection, a wireless connection, a virtual network, or the like) using any suitable transport network. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BSs for the femto cells 102y and 102z, respectively. A BS may support one or multiple cells.

The BSs 110 communicate with UEs 120a-y (each also individually referred to herein as UE 120 or collectively as UEs 120) in the wireless communication network 100. The UEs 120 (e.g., 120x, 120y, etc.) may be dispersed throughout the wireless communication network 100, and each UE 120 may be stationary or mobile. Wireless communication network 100 may also include relay stations (e.g., relay station 110r), also referred to as relays or the like, that receive a transmission of data and/or other information from an upstream station (e.g., a BS 110a or a UE 120r) and sends a transmission of the data and/or other information to a downstream station (e.g., a UE 120 or a BS 110), or that relays transmissions between UEs 120, to facilitate communication between devices.

A network controller 130 may be in communication with a set of BSs 110 and provide coordination and control for these BSs 110 (e.g., via a backhaul). In aspects, the network controller 130 may be in communication with a core network 132 (e.g., a 5G Core Network (5GC)), which provides various network functions such as Access and Mobility Management, Session Management, User Plane Function, Policy Control Function, Authentication Server Function, Unified Data Management, Application Function, Network Exposure Function, Network Repository Function, Network Slice Selection Function, etc.

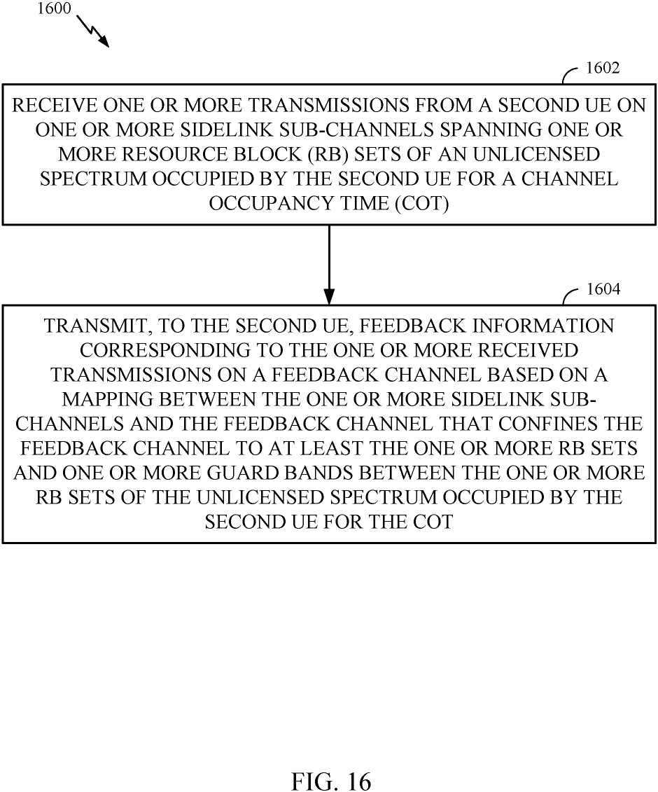

According to certain aspects, the UEs 120 may be configured for transmitting feedback information on a sidelink feedback channel in an unlicensed spectrum according to a sidelink feedback channel resource mapping, as described herein. For example, as shown in FIG. 1, each of the UE 120a and the UE 120b includes a respective sidelink feedback manager 122.The sidelink feedback manager 122 may be configured to perform the operations illustrated in FIG. 16, as well as other operations described herein for transmitting feedback information on a sidelink feedback channel in an unlicensed spectrum according to a sidelink feedback channel resource mapping.

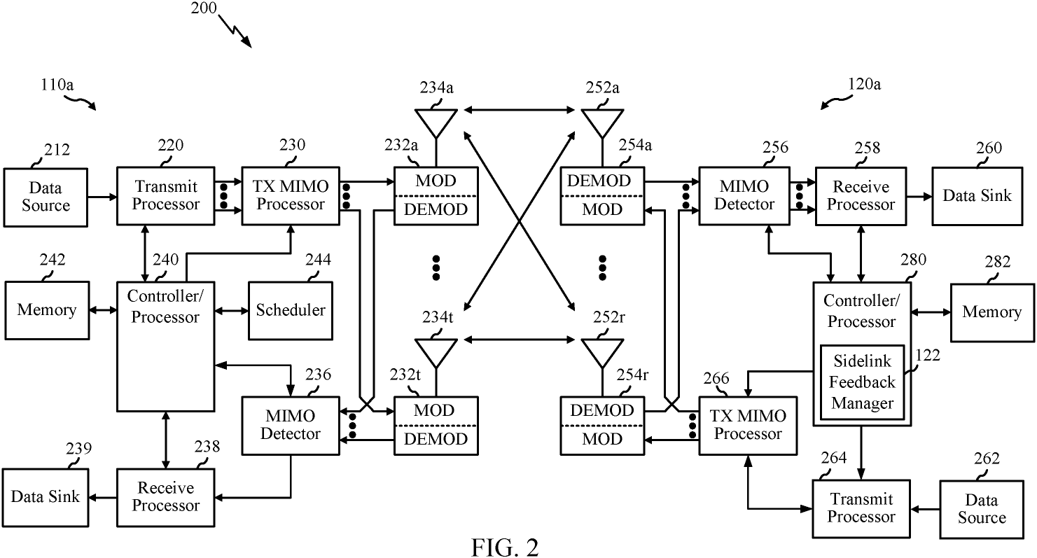

FIG. 2 illustrates example components of BS 110a and UE 120a (e.g., the wireless communication network 100 of FIG. 1), which may be used to implement aspects of the present disclosure.

At the BS 110a, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), etc. The data may be for the physical downlink shared channel (PDSCH), etc. A medium access control (MAC)-control element (MAC-CE) is a MAC layer communication structure that may be used for control command exchange between wireless nodes. The MAC-CE may be carried in a shared channel such as a physical downlink shared channel (PDSCH), a physical uplink shared channel (PUSCH), or a physical sidelink shared channel (PSSCH).

The processor 220 may process (e.g., encode and symbol map) the data and control information to obtain data symbols and control symbols, respectively. The transmit processor 220 may also generate reference symbols, such as for the primary synchronization signal (PSS), secondary synchronization signal (SSS), PBCH demodulation reference signal (DMRS), and channel state information reference signal (CSI-RS). A transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a- 232t may process a respective output symbol stream (e.g., for OFDM, etc.) to obtain an output sample stream. Each modulator may further process (e.g., convert to analog, amplify, filter, and upconvert) the output sample stream to obtain a downlink signal. Downlink signals from modulators in transceivers 232a-232t may be transmitted via the antennas 234a-234t, respectively.

At the UE 120a, the antennas 252a-252r may receive the downlink signals from the BS 110a and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples (e.g., for OFDM, etc.) to obtain received symbols. A MIMO detector 256 may obtain received symbols from all the demodulators in transceivers 254a-254r, perform MIMO detection on the received symbols if applicable, and provide detected symbols. A receive processor 258 may process (e.g., demodulate, deinterleave, and decode) the detected symbols, provide decoded data for the UE 120a to a data sink 260, and provide decoded control information to a controller/processor 280.

On the uplink, at UE 120a, a transmit processor 264 may receive and process data (e.g., for the physical uplink shared channel (PUSCH)) from a data source 262 and control information (e.g., for the physical uplink control channel (PUCCH) from the controller/processor 280. The transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM, etc.), and transmitted to the BS 110a. At the BS 110a, the uplink signals from the UE 120a may be received by the antennas 234, processed by the modulators in transceivers 232a-232t, detected by a MIMO detector 236 if applicable, and further processed by a receive processor 238 to obtain decoded data and control information sent by the UE 120a. The receive processor 238 may provide the decoded data to a data sink 239 and the decoded control information to the controller/processor 240.

The memories 242 and 282 may store data and program codes for BS 110a and UE 120a, respectively. A scheduler 244 may schedule UEs for data transmission on the downlink and/or uplink.

Antennas 252, processors 266, 258, 264, and/or controller/processor 280 of the UE 120a and/or antennas 234, processors 220, 230, 238, and/or controller/processor 240 of the BS 110a may be used to perform the various techniques and methods described herein. As shown in FIG. 2, the controller/processor 280 of the UE 120a has the sidelink feedback manager 122 that may be configured to perform the operations illustrated in FIG. 16, as well as other operations disclosed herein for transmitting feedback information on a sidelink feedback channel in an unlicensed spectrum according to a sidelink feedback channel resource mapping. Although shown at the controller/processor, other components of the UE 120a and BS 110a may be used to perform the operations described herein.

NR may utilize orthogonal frequency division multiplexing (OFDM) with a cyclic prefix (CP) on the uplink and downlink. NR may support half-duplex operation using time division duplexing (TDD). OFDM and single-carrier frequency division multiplexing (SC-FDM) partition the system bandwidth into multiple orthogonal subcarriers, which are also commonly referred to as tones, bins, etc. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a resource block (RB), may be 12 consecutive subcarriers. The system bandwidth may also be partitioned into subbands. For example, a subband may cover multiple RBs. NR may support a base subcarrier spacing (SCS) of 15 KHz and other SCS may be defined with respect to the base SCS (e.g., 30 kHz, 60 kHz, 120 kHz, 240 kHz, etc.).

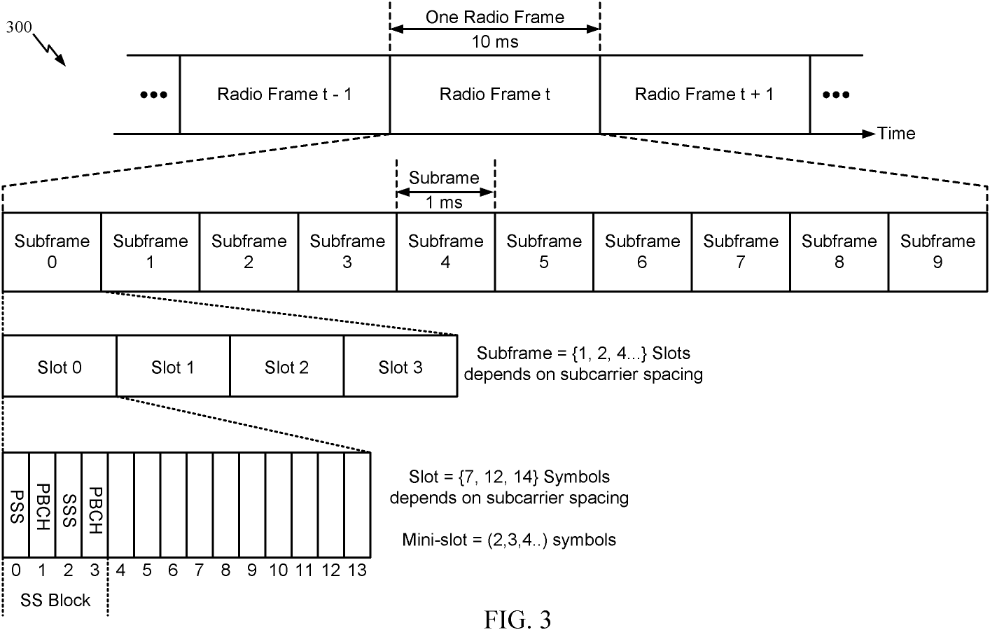

FIG. 3 is a diagram showing an example of a frame format 300 for NR. The transmission timeline for each of the downlink and uplink may be partitioned into units of radio frames. Each radio frame may have a predetermined duration (e.g., 10 ms) and may be partitioned into 10 subframes, each of 1 ms, with indices of 0 through 9. Each subframe may include a variable number of slots (e.g., 1, 2, 4, 8, 16, ... slots) depending on the SCS. Each slot may include a variable number of symbol periods (e.g., 7, 12, or 14 symbols) depending on the SCS. The symbol periods in each slot may be assigned indices. A mini-slot, which may be referred to as a sub-slot structure, refers to a transmit time interval having a duration less than a slot (e.g., 2, 3, or 4 symbols). Each symbol in a slot may indicate a link direction (e.g., DL, UL, or flexible) for data transmission and the link direction for each subframe may be dynamically switched. The link directions may be based on the slot format. Each slot may include DL/UL data as well as DL/UL control information.

In NR, a synchronization signal block (SSB) is transmitted. In certain aspects, SSBs may be transmitted in a burst where each SSB in the burst corresponds to a different beam direction for UE-side beam management (e.g., including beam selection and/or beam refinement). The SSB includes a PSS, a SSS, and a two symbol PBCH. The SSB can be transmitted in a fixed slot location, such as the symbols 0-3 as shown in FIG. 3. The PSS and SSS may be used by UEs for cell search and acquisition. The PSS may provide half-frame timing, the SS may provide the CP length and frame timing. The PSS and SSS may provide the cell identity. The PBCH carries some basic system information, such as downlink system bandwidth, timing information within radio frame, SS burst set periodicity, system frame number, etc. The SSBs may be organized into SS bursts to support beam sweeping. Further system information such as, remaining minimum system information (RMSI), system information blocks (SIBs), other system information (OSI) can be transmitted on a physical downlink shared channel (PDSCH) in certain subframes. The SSB can be transmitted up to sixty-four times, for example, with up to sixty-four different beam directions for mmWave. The multiple transmissions of the SSB are referred to as a SS burst set. SSBs in an SS burst set may be transmitted in the same frequency region, while SSBs in different SS bursts sets can be transmitted at different frequency regions.

### Example Sidelink Communication

In some examples, two or more subordinate entities (e.g., UEs 120) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE 120a) to another subordinate entity (e.g., another UE 120) without relaying that communication through the scheduling entity (e.g., UE 120 or BS 110), even though the scheduling entity may be utilized for scheduling and/or control purposes. In some examples, the sidelink signals may be communicated using a licensed spectrum (unlike wireless local area networks, which typically use an unlicensed spectrum). One example of sidelink communication is PC5, for example, as used in V2V, LTE, and/or NR.

Various sidelink channels may be used for sidelink communications, including a physical sidelink discovery channel (PSDCH), a physical sidelink control channel (PSCCH), a physical sidelink shared channel (PSSCH), and a physical sidelink feedback channel (PSFCH). The PSDCH may carry discovery expressions that enable proximal devices to discover each other. The PSCCH may carry control signaling such as sidelink resource configurations, resource reservations, and other parameters used for data transmissions, and the PSSCH may carry the data transmissions. The PSFCH may carry feedback such as acknowledgement (ACK) and or negative ACK (NACK) information corresponding to transmissions on the PSSCH. In some systems (e.g., NR Release 16), a two stage SCI may be supported. Two stage SCI may include a first stage SCI (SCI-1) and a second stage SCI (e.g., SCI-2). SCI-1 may include resource reservation and allocation information, information that can be used to decode SCI-2, etc. SCI-2 may include information that can be used to decode data and to determine whether the UE is an intended recipient of the transmission. SCI-1 and/or SCI-2 may be transmitted over PSCCH.

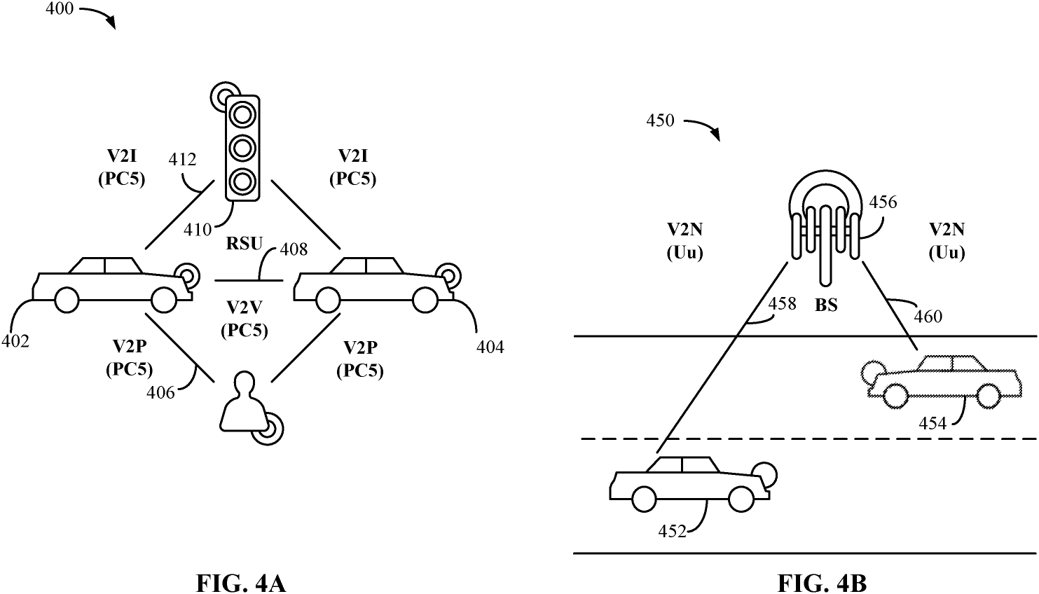

FIG. 4A and FIG. 4B show diagrammatic representations of example V2X systems, in accordance with some aspects of the present disclosure. For example, the vehicles shown in FIG. 4A and FIG. 4B may communicate via sidelink channels and may relay sidelink transmissions as described herein.

The V2X systems provided in FIG. 4A and FIG. 4B provide two complementary transmission modes. A first transmission mode (also referred to as mode 4), shown by way of example in FIG. 4A, involves direct communications (for example, also referred to as sidelink communications) between participants in proximity to one another in a local area. A second transmission mode (also referred to as mode 3), shown by way of example in FIG. 4B, involves network communications through a network, which may be implemented over a Uu interface (for example, a wireless communication interface between a radio access network (RAN) and a UE).

Referring to FIG. 4A, a V2X system 400 (for example, including vehicle-to-vehicle (V2V) communications) is illustrated with two vehicles 402, 404. The first transmission mode allows for direct communication between different participants in a given geographic location. As illustrated, a vehicle can have a wireless communication link 406 with an individual (V2P) (for example, via a UE) through a PC5 interface. Communications between the vehicles 402 and 404 may also occur through a PC5 interface 408. In a like manner, communication may occur from a vehicle 402 to other highway components (for example, highway component 410), such as a traffic signal or sign (V2I) through a PC5 interface 412. With respect to each communication link illustrated in FIG. 4A, two-way communication may take place between elements, therefore each element may be a transmitter and a receiver of information. The V2X system 400 may be a self-managed system implemented without assistance from a network entity. A self-managed system may enable improved spectral efficiency, reduced cost, and increased reliability as network service interruptions do not occur during handover operations for moving vehicles. The V2X system may be configured to operate in a licensed or unlicensed spectrum, thus any vehicle with an equipped system may access a common frequency and share information. Such harmonized/common spectrum operations allow for safe and reliable operation.

FIG. 4B shows a V2X system 450 for communication between a vehicle 452 and a vehicle 454 through a network entity 456. These network communications may occur through discrete nodes, such as a BS (e.g., the BS 110a), that sends and receives information to and from (for example, relays information between) vehicles 452, 454. The network communications through vehicle to network (V2N) links 458 and 460 may be used, for example, for long-range communications between vehicles, such as for communicating the presence of a car accident a distance ahead along a road or highway. Other types of communications may be sent by the wireless node to vehicles, such as traffic flow conditions, road hazard warnings, environmental/weather reports, and service station availability, among other examples. Such data can be obtained from cloud-based sharing services.

Roadside units (RSUs) may be utilized. An RSU may be used for V2I communications. In some examples, an RSU may act as a forwarding node to extend coverage for a UE. In some examples, an RSU may be co-located with a BS or may be standalone. RSUs can have different classifications. For example, RSUs can be classified into UE-type RSUs and Micro NodeB-type RSUs. Micro NodeB-type RSUs have similar functionality as a Macro eNB or gNB. The Micro NodeB-type RSUs can utilize the Uu interface. UE-type RSUs can be used for meeting tight quality-of-service (QoS) requirements by minimizing collisions and improving reliability. UE-type RSUs may use centralized resource allocation mechanisms to allow for efficient resource utilization. Critical information (e.g., such as traffic conditions, weather conditions, congestion statistics, sensor data, etc.) can be broadcast to UEs in the coverage area. Relays can rebroadcasts critical information received from some UEs. UE-type RSUs may be a reliable synchronization source.

### Example Sidelink Feedback Channel Resource Mapping in Unlicensed Spectrum

When communicating on a sidelink a UE may use resources selected from a resource pool. The resource pool may be defined as a consecutive number of resource blocks (RBs) in the frequency domain in units of sub-channels. In other words, a resource pool may be composed of a plurality of consecutive RBs in frequency. In particular, a sub-channel may be defined as one or more of the RBs (e.g., that are consecutive), and a resource pool may be defined as one or more sub-channels.

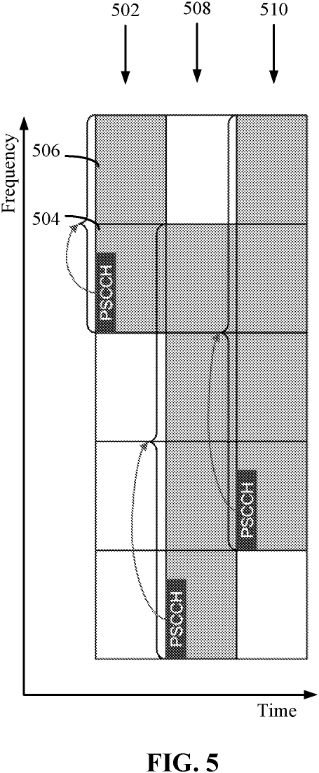

FIG. 5 shows a time-frequency grid illustrating example resource pools for sidelink communication, according to certain aspects presented here. As can be seen, three different resource pools (e.g., 502, 504, and 506) are shown. The resource pool 502 may be composed of two sub-channels 508 (e.g., assigned a physical sidelink control channel (PSCCH) and a physical sidelink shared channel (PSSCH)) and 510 (e.g., assigned to the PSSCH), each of the two sub-channels 508 and 510 including a consecutive set of RBs spanning different frequencies. As shown, resources pool 504 and 506 may each include four sub-channels spanning different frequency bands.

In some cases, a sidelink resource pool may be defined by a number of parameters, such as the parameters sl-StartRB-Subchannel, sl-SubchannelSize, and sl-NumSubchannel, though it should be noted that they can be referred to in any suitable way. The parameter sl-StartRB-Subchannel may define the first RB of the lowest index sub-channel of the resource pool. For example, with reference to resource pool 502, the parameter sl-StartRB-Subchannel may specify the first RB of the sub-channel 508. Additionally, the parameter sl-SubchannelSize may define the number of RBs of each sub-channel in the resource pool and the parameter sl-NumSubchannel may define the number of sub-channels in the resource pool. Accordingly, for example, with reference to resource pool 502, the parameter sl-NumSubchannel may define resource pool 502 to include two sub-channels (e.g., 508 and 510) and the parameter sl-SubchannelSize may define that each of sub-channels 508 and 510 include 10 RBs to 100 RBs.

In some cases, within each subchannel, a sidelink control channel, such as a physical sidelink control channel (PSCCH), may occupy a first number of RBs (e.g., where the number is the value of the parameter sl-FreqResourcePSCCH) and a first number of symbols (e.g., where the number is the value of a parameter sl-TimeResourcePSCCH) of the first sub-channel assigned to a sidelink shared data channel, such as a physical sidelink shared channel (PSSCH). In some cases, control information included in the PSCCH may allocate, starting from a current sub-channel in which the PSCCH is transmitted, how many sub-channels may be included within the PSSCH.

In some cases, a UE may need to transmit feedback information to indicate whether certain transmissions on a PSSCH and/or PSCCH have been successfully received or not. This feedback information may include acknowledgement (ACK) that a transmission was successfully received and decoded and/or negative ACK (NACK) that a transmission was not successfully decoded corresponding to the transmissions on the PSSCH/PSCCH. In some cases, this feedback information may be transmitted on a feedback channel, known as a physical sidelink feedback channel (PSFCH). In order to transmit feedback information on the PSFCH, a set of resources may be selected from a non-dedicated PSFCH resource pool.

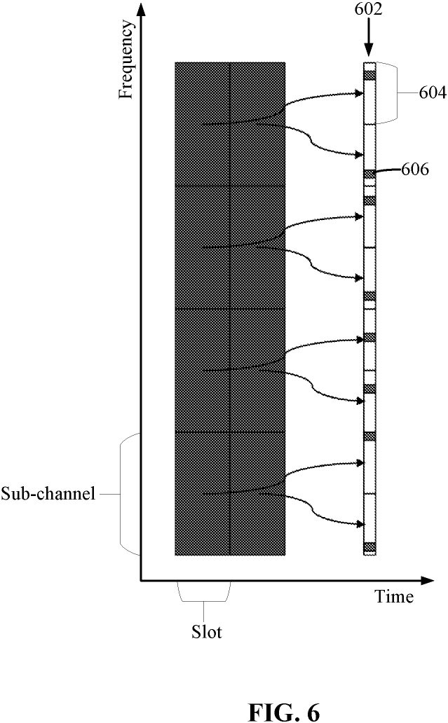

An example PSFCH resource pool 602 is illustrated in FIG. 6. As shown, the PSFCH resource pool 602 may be separated into a set of separate sub-resource pools 604 each corresponding to a different sidelink sub-channels across different time slots. Though certain aspects are described in terms of slots, other appropriate time durations may similarly be used. For example, as shown in FIG. 6, a total of eight sub-channels across two time slots may be used to carry PSSCH/PSCCH information. Accordingly, the PSFCH resource pool 602 may be separated into eight different sub-resource pools 604 for carrying feedback information corresponding to the eight different sub-channels across the two time slots. Each sub-resource pool 604 may include a plurality of resources (e.g., RBs) and the UE may select one resource 606 of the plurality of resources within the sub-resource pool 604 to transmit the feedback information for each sub-channel.

The UE may determine the PSFCH resource pool and select resources for transmitting the feedback information based on a number of parameters. Though certain names are given for such parameters, it should be noted they may be referred to in any suitable manner. For example, in some cases, the UE may be configured with the parameter periodPSFCHresource, which may indicate a period in slots for PSFCH transmission in a resource pool. In some cases, the supported periods are 0/1/2/4, where 0 means no PSFCH. In certain aspects, PSFCH transmission timing may be determined to be the first slot with PSFCH resources after reception of a PSSCH and after MinTimeGapPSFCH (e.g., a time value) after PSSCH. In some cases, the parameter

$${M}_{P R B , s e t}^{P S F C H}$$

may defines a set of PRBs for PSFCH in a slot. As discussed above, this set of PRBs may be split between

$${N}_{P S S C H}^{P S F C H}$$

(e.g., the number of PSSCH slots corresponding to the PSFCH slot) and N_{subch} PSSCH (e.g., the number of PSSCH sub-channels) in a slot. Accordingly, each sub-channel/slot may have

$${M}_{s u b c h , s l o t}^{P S F C H} = \frac{{M}_{P R B , s e t}^{P S F C H}}{{N}_{P S S C H}^{P S F C H} \times {N}_{s u b c h}}$$

PRBs for PSFCH. In some cases, mapping may be performed time-first from PSSCH resource to PSFCH PRBs.

A size of the PSFCH resource pool may be defined according to

$${R}_{P R B , C S}^{P S F C H} =$$

$${N}_{t y p e}^{P S F C H} \times {N}_{C S}^{P S F C H} \times {M}_{s u b c h , s l o t}^{P S F C H} ,$$

where

$${N}_{s u b c h}^{P S S C H} ,$$

is the number of cyclic shift (CS) pairs configured per RB in the resource pool (e.g., where the pair is for a 1 bit ACK/NACK). In certain aspects

$${N}_{t y p e}^{P S F C H}$$

is 1 or

$${N}_{s u b c h}^{P S S C H} ,$$

indicating for the sub-channels in a PSSCH slot whether the PSFCH resource pool is shared or not. In some cases, within the pool, the PSFCH resources may be indexed in PRB index, then in CS pair index.

In some cases, the UE may determine a PSFCH resource to use for transmitting the feedback information according to (P_{ID} + M_{ID})mod

$${R}_{P R B , C S}^{P S F C H} ,$$

where P_{ID} is a physical source ID from sidelink control information (SCI) 0-2 for PSSCH and M_{ID} is 0 or identifies the UE receiving the PSSCH. In certain aspects, for unicast or NAK based transmission, M_{ID} = 0 and the UE may send ACK or NAK only at a source ID dependent resource in the pool. For group cast, in certain aspects, a destination ID may be used to select one resource in the resource pool for transmitting the feedback information.

In some cases, it may be beneficial to perform sidelink communication using wideband channel operation within an unlicensed spectrum in order to take advantage of globally-available “free” spectrum. However, the allocation of resources in the unlicensed spectrum may be different from that of sidelink communication.

For example, for operation in an unlicensed spectrum, as there may be an issue with coexistence with WiFi, channel access in the unlicensed spectrum may be divided among a plurality of 20 MHz subbands, even when the system is operating in wideband mode (e.g., multiples of 20 MHz). To be able to access a particular 20 MHz subband, a wireless device (e.g., UE) may first perform a listen before talk (LBT) procedure to determine whether that 20 MHz subband is available for use by the wireless device. A 20 MHz subband may be available for use if the wireless device senses that there are no other transmissions occurring in this 20 MHz subband for a period of time, indicating that the 20 MHz subband is in an idle state. In some cases, the wireless device may conclude that the 20 MHz subband is in the idle state by sensing an energy level on the 20 MHz subband. If the energy level of the 20 MHz subband is below a threshold, the wireless device may conclude that the 20 MHz subband is available for use. If, however, the LBT procedure does not pass (e.g., an energy level of the 20 MHz subband is greater than a threshold), the wireless device may try another 20 MHz bandwidth part. It should be noted that a 20 MHz subband is only an example, and a subbant may have a different bandwidth.

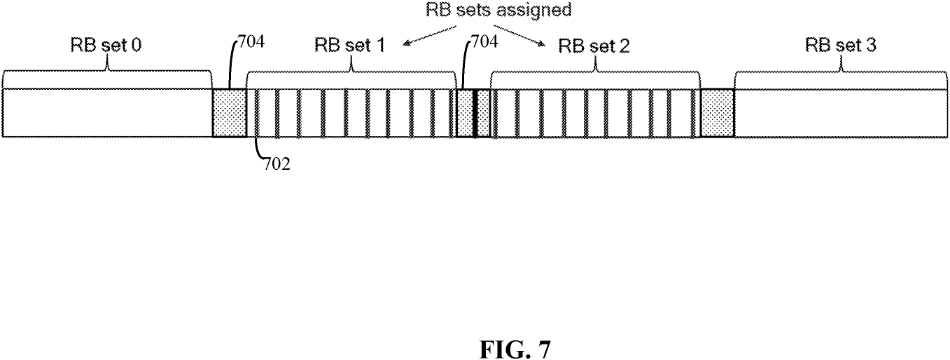

To support this type of operation, such as in 5G new radio-unlicensed (NR-U), an intra-cell guard band is introduced to define guard band between each (e.g., approximately 20 MHz) subbands. The passband between two adjacent intra-cell guard band may be known as an “RB set,” which is approximately 20 MHz. For example, as illustrated in FIG. 7, the unlicensed spectrum may be split up into a plurality of RB sets, (e.g., each spanning roughly 20 MHz of bandwidth) including a plurality of RBs 702. As shown in the example illustrated in FIG. 7, the unlicensed spectrum may be divided into four different RB sets, including RB set 0, RB set 1, RB set 2, and RB set 3, and intra-cell guard bands 704 may be inserted between each RB set. It should be noted there may be a greater or lesser number of RB sets, and they may have a greater or lesser bandwidth/number of RBs. As noted above, to communicate using the unlicensed spectrum, a wireless device may perform a LBT procedure to sense which RB sets are available for communication. As shown in FIG. 7, RB set 1 and RB set 2 have passed the LBT procedure and are available for use/assignment by the wireless device.

In some cases, a (e.g., NR-U) system may support both contiguous and interlaced uplink resource allocations while complying with regulations. In the interlaced uplink resource allocation, the basic unit of resource allocation for the NR unlicensed channels is an interlace, which, for example, as illustrated in FIG. 7, is composed of ten equally spaced RBs 702 within a 20 MHz frequency bandwidth (e.g., RB set) for 15 KHz sub-carrier spacing. In certain aspects, for RBs that belong to an assigned set of interlaces but that fall in an intra-cell guard band, such RBs will be assigned only if the RB sets on both sides are assigned. Further, in some cases a wireless device, such as a UE, may transmit in the intra-cell guard band 704 if both RB sets on either side of the intra-cell guard band are allocated to the UE. Likewise, in some cases, a UE may also receive transmissions within the intra-cell guard band 704 if the UE is a high-capability UE. However, if the UE is a lower-capability UE, the UE may only be able to receive transmissions within an RB set and may not receive transmissions in the intra-cell guard band 704. In some cases, a UE may transmit information to a base station, indicating a capability of the UE. If the capability information indicates that the UE is a low-capability UE, the base station may avoid scheduling a physical data shared channel (PDSCH) on guard band RBs to this low-capability UE.

As noted above, it may be beneficial to perform sidelink communication using wideband channel operation within an unlicensed spectrum in order to take advantage of globally-available “free” spectrum. However, an issue that may exist with performing sidelink communication in the unlicensed spectrum is due to the way in which sidelink sub-channels are defined with respect to the way in which RB sets are defined within the unlicensed spectrum. For example, as noted above, sub-channels in the sidelink may be defined consecutively, without any spacing between different sub-channels. This presents an issue when mapping these consecutively-defined sub-channels to RB sets in the unlicensed band that include intra-cell guard bands disposed between RB sets. For example, if the sidelink sub-channels are defined in a legacy fashion in which the sub-channels are consecutive, some sidelink sub-channels may partially overlap with intra-cell guard bands in the unlicensed spectrum, which may lead to these sidelink sub-channel being unusable by certain UEs (e.g., low-capability UEs) in the unlicensed spectrum. Thus, in some case, to help alleviate these issues, side-link sub-channels may be confined within RB sets of the unlicensed spectrum, such that no sidelink sub-channel overlaps an intra-cell guard band. Thus, by confining the sidelink sub-channels to fit within RB sets of the unlicensed spectrum usage of each sidelink sub-channel only depends on the LBT of the RB set in which that sidelink sub-channel is confined.

Additionally, in some cases (e.g., NR-U), the concept of channel occupancy time (COT) sharing has been introduced such that a COT on a particular subband (e.g., RB set) acquired by a transmitter device (e.g., UE) via a passing LBT procedure on that subband may be shared with another device (e.g., UE). For example, a COT for a frequency band/subband may designate an interval of time that a transmitter device can transmit via the frequency band continuously before yielding the channel, e.g., stopping transmitting via the frequency band for a period to allow another device to possibly perform a LBT and begin transmitting via the frequency band.

In some cases, a COT for a frequency band may be limited by regulations to a certain time interval (e.g., 2 msec to 10 msec), depending on the market, the frequency band, technical considerations such as priority of the signal, and duration of the corresponding LBT procedure (typically, the larger the duration of the LBT procedure, the greater the corresponding COT). In some cases, it may be desirable for a COT to be shared by multiple UEs. In COT sharing, the principle is that one UE acquires the COT by performing an LBT (e.g., a category 4 (Cat4) LBT), and other UEs can share the same COT (i.e., initiate transmissions without performing an LBT) until the duration of the COT is exhausted. COT sharing may come in at least two varieties: TDM style COT sharing, where a COT is shared by time multiplexing (e.g., UEs transmit one after another until the COT duration is exhausted), and FDM style COT sharing, where a COT is shared by frequency multiplexing (e.g., UEs transmit simultaneously on different sub-channels of a frequency band to which the COT applies). In some cases, the two varieties of COT sharing can also be combined.

This concept of COT sharing may also be applicable to transmission of feedback information on a sidelink feedback channel. For example, in some cases, after performing LBT to acquire a COT on a particular RB set and transmitting a PSCCH/PSSCH, a transmitting node (e.g., UE) may share the COT with a responding node, allowing the responding node to transmit feedback information in a PSFCH using the same COT. However, given current conventional PSCCH/PSSCH to PSFCH mapping, the PSFCH may be in a different subband, preventing COT sharing (e.g., since the subband for the PSFCH may not be the subband reserved for the COT).

Thus, aspects of the present disclosure provide techniques for allowing transmission of feedback information on a sidelink feedback channel using COT sharing. In some cases, such techniques may include taking into account the definition of RB sets when configuring a PSFCH resource pool for transmitting feedback information corresponding to PSCCH/PSSCH. For example, in some cases, a PSCCH/PSSCH to PSFCH mapping may be updated such that the PSFCH for the PSCCH/PSSCH is confined within the same subband (e.g., one or more RB sets) as the PSCCH/PSSCH. More generally, in some cases, the mapping may confine the PSFCH to one or more RB sets of the unlicensed spectrum occupied by the second UE.

Accordingly, in some cases, techniques for allowing transmission of feedback information on a sidelink feedback channel using COT sharing may include a first UE receiving one or more transmissions from a second UE on one or more sidelink sub-channels spanning one or more RB sets of an unlicensed spectrum occupied by the second UE for a COT and transmitting, to the second UE, feedback information corresponding to the one or more received transmissions on a feedback channel based on a mapping between the one or more sidelink sub-channels and the feedback channel that confines the feedback channel to at least the one or more RB sets and one or more guard bands between the one or more RB sets of the unlicensed spectrum occupied by the second UE for the COT

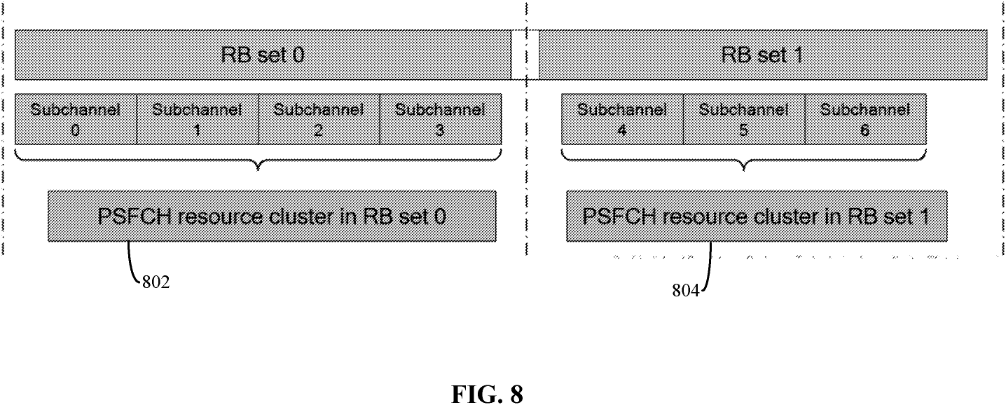

FIG. 8 provides an example of a mapping between one or more sidelink sub-channels and a sidelink feedback channel, in accordance with certain aspects presented herein. As illustrated, the mapping shown in FIG. 8 may confine the feedback channel (e.g., PSFCH) to the same RB set(s) in which the PSCCH/PSSCH is transmitted. For example, as illustrated, a plurality of RB sets (e.g., RB set 0 and RB set 1) may be defined within an unlicensed spectrum. Additionally, as illustrated, so that no sidelink sub-channels overlap an intra-cell guard band, sidelink sub-channels may be fully confined within the defined RB sets. For example, as illustrated, a first set of sidelink sub-channels (e.g., sidelink sub-channels 0-3) may be confined to RB set 0 while a second set of sidelink sub-channels (e.g., sidelink sub-channels 4-6) may be confined to RB set 1.

In some cases, the second UE discussed above (e.g., a transmitting/initiator UE) may perform a LBT procedure to reserve an RB set for the duration of a COT in order to transmit a PSCCH/PSSCH to the first UE discussed above (e.g., receiving/responding UE) using one or more of the sidelink sub-channels defined within the reserved/occupied RB set. To allow transmission of feedback information on a PSFCH corresponding to the received PSCCH/PSSCH via COT sharing, a PSFCH resource pool/cluster may be mapped to the one or more sidelink sub-channels over which the PSCCH/PSSCH is received such that the PSFCH is confined to the same RB set occupied by the transmitting device for the COT.

In some cases, as shown, the mapping between the one or more sidelink sub-channels and the PSFCH may define a separate resource pool for the PSFCH for each RB set of the one or more RB sets occupied by the second UE. For example, as illustrated in FIG. 8, if the second UE occupies RB set 0 and the PSCCH/PSSCH is received on one of the sidelink sub-channels defined within RB set 0 (e.g., sidelink sub-channels 0-3), a PSFCH resource pool 802 for transmitting feedback information corresponding to the PSCCH/PSSCH may be confined to RB set 0. Similarly, as illustrated, if the second UE occupies RB set 1 and the PSCCH/PSSCH is received on one of the sidelink sub-channels defined within RB set 1 (e.g., sidelink sub-channels 4-6), a PSFCH resource pool 804 for transmitting feedback information corresponding to the PSCCH/PSSCH may be confined to RB set 1. Accordingly, by confining the PSFCH resource pool to the RB set in which the PSCCH/PSSCH is received, it can be ensured that the first UE may be able to share the same COT as the second UE since the feedback information will be transmitted by the first UE within the same RB set occupied by the second UE.

In some cases, there may be different ways to associate the PSCCH/PSSCH to the PSFCH. For example, in some cases, a per-RB set PSCCH/PSSCH sub-channel to PSFCH resource mapping may be introduced. This approach may essentially equate to updating a legacy sub-channel to PSFCH mapping to mapping sub-channels within an RB set to PSFCH resources in the same RB set. For example, in this case, the mapping may define a separate resource pool for the feedback channel for each RB set occupied by the second UE.

In other cases, a physical resource indicator (PRI)-type indication in sidelink control information (SCI) (e.g., SCI1 or SCI2) may be used to indicate the PSFCH resource pool. Accordingly, in some cases, the first UE may receive a PRI from the second UE in a SCI granting a COT occupied by the second UE to the first UE. The first UE may then determine the resource pool for transmitting the feedback information on the PSFCH based on the PRI. In some cases, the PSFCH resource pool to be addressed by the PRI may depend on the LBT outcome at the second UE. Additionally, in some cases, a set of PSFCH resources can be identified by a frequency domain resource allocation (FDRA) field in SCI1 (e.g., so the receiver UE knows which RB sets pass LBT).

In some cases, there may be different ways of implementing the PRI indication to indicate the PSFCH resource pool. For example, in some cases, a PRI addressable space for the PSFCH resource pool may be confined within the same RB set as the RB set in which PSCCH carried. For example, in this case, the second UE may transmit a PSCCH in one or more sidelink sub-channels of one or more RB sets and, based on the PRI, the mapping between the one or more sidelink sub-channels and the feedback channel (e.g., PSFCH) may confine the feedback channel to the one or more RB sets occupied by/carrying the PSCCH.

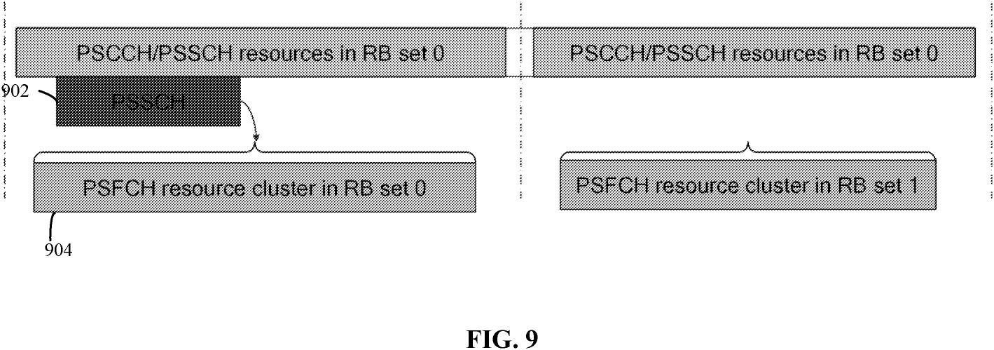

In other cases, the PRI addressable space for the PSFCH resource pool may be confined within the RB sets (e.g., partially) occupied by the PSSCH (e.g., the RB sets that LBT should pass to support the PSSCH transmission). For example, in this case, the second UE may transmit a PSSCH in one or more sidelink sub-channels of one or more RB sets and, based on the PRI, the mapping between the one or more sidelink sub-channels and the feedback channel (e.g., PSFCH) may confine the feedback channel to the one or more RB sets occupied by/carrying the PSSCH. An example of this mapping is illustrated in FIG. 9.

For example, as illustrated in FIG. 9, a PSSCH 902 may be transmitted by the second UE within resources of RB set 0. Accordingly, because the PSSCH 902 is transmitted in RB set 0, the resource pool 904 for the feedback channel (e.g., PSFCH) may also be confined to RB set 0, which may be indicated to the first UE by PRI in SCI. The first UE may use the PRI to determine the resource pool for the PSFCH and may transmit feedback information based on the determine resource pool.

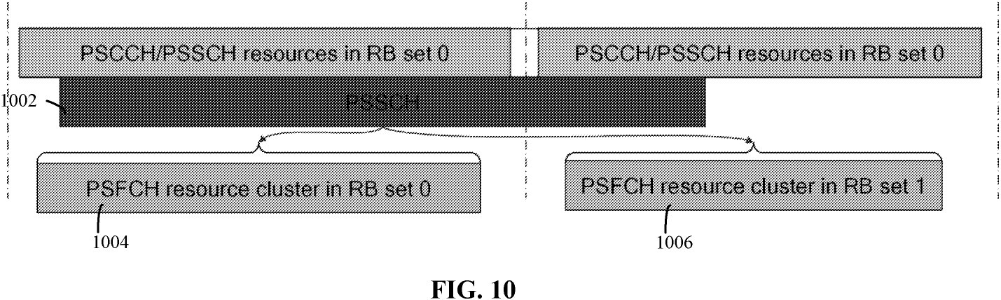

In some cases, however, the PSSCH may spans at least two RB sets of the one of more RB sets, as illustrated in FIG. 10. For example, as illustrated in FIG. 10, the second UE may transmit a PSSCH across multiple RB sets, such as RB set 0 and RB set 1. Accordingly, because the PSSCH in this case spans two different RB sets, two different PSFCH may be defined for transmitting feedback information corresponding to the PSSCH. For example, as illustrated, in this case, a first PSFCH resource pool 1004 may be defined for RB set 0 and a second PSFCH resource pool 1006 may be defined for RB set 1. The UE may determine which PSFCH resource pool to use to transmit the feedback information corresponding to the PSSCH based, for example, on PRI received in SCI. For example, in this case, because the PSSCH spans two RB sets (RB set 0 and RB set 1), the PRI may indicate the PSFCH resource pool of one RB set of the two RB sets (e.g., the first PSFCH resource pool 1004 or the second PSFCH resource pool 1006) to use for transmitting the feedback information on the feedback channel (e.g., PSFCH).

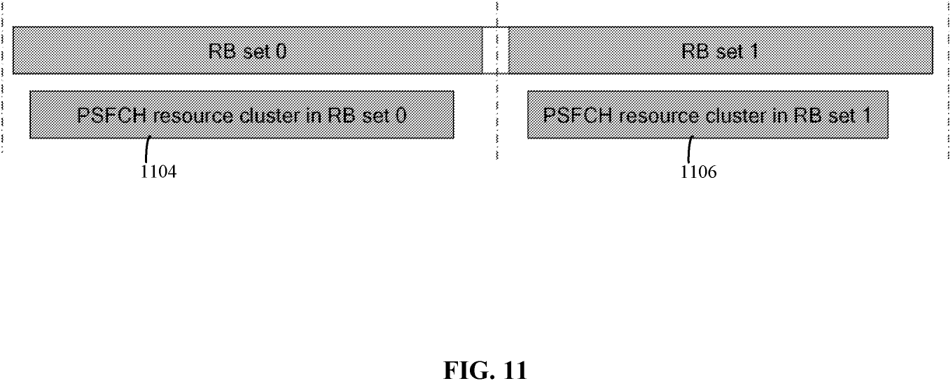

In some cases, when the PSSCH is transmitted across multiple RB sets, the PSFCH resource pools corresponding to the PSSCH may be defined in different manners. In certain aspects, such definitions are configured at the UE using RRC signaling by a base station. For example, in one example illustrated in FIG. 11, the PSFCH resources pools may be defined by a starting RB and a number of RBs for each PSFCH resource pool. In this case, a base station (e.g., gNB) may be responsible to confine each PSFCH resource pool/cluster within an RB set. For example, as illustrated in FIG. 11, a PSFCH resource pool may be defined for each RB set in which the PSSCH is transmitted, such as PSFCH resource pool 1104 defined for RB set 0 and PSFCH resource pool 1106 for RB set 1. As noted, the PSFCH resource pool 1104 and the PSFCH resource pool 1106 may be defined according to a starting RB for each PSFCH resource pool within their respective RB set as well a number of RBs included within the resource pool within that RB set.

Accordingly, in some cases, when the PSSCH is transmitted across multiple RB sets, the first UE may determine a resource pool for each RB set of the one or more RB sets. For example, with reference to FIG. 11, the first UE may determine the PSFCH resource pool 1104 for RB set 0 and PSFCH resource pool 1106 for RB set 1. In some cases, as noted above, the first UE may UE may determine the PSFCH resource pool 1104 and PSFCH resource pool 1106 based, at least in part on an indication of a starting RB for each PSFCH resource pool within their respective RB sets and a number of RBs included within the PSFCH resource pool within that RB set.

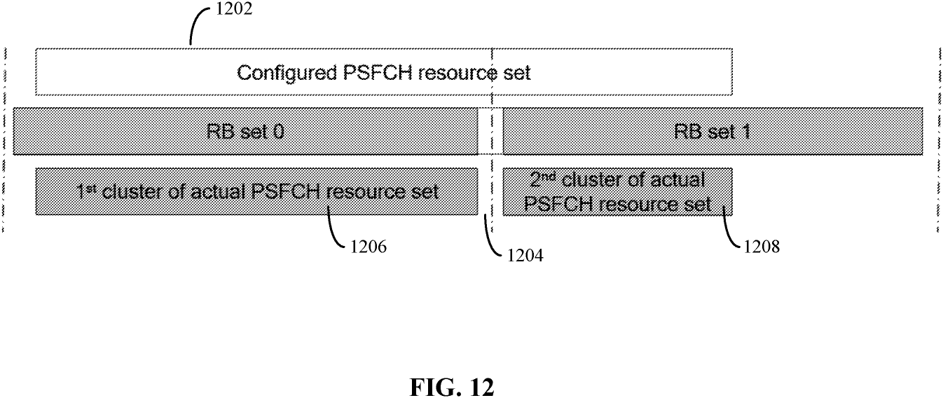

In other cases, when the PSSCH is transmitted across multiple RB sets, the PSFCH resource pools corresponding to the PSSCH may be defined by removing RBs within the one or more guard bands from RBs included within a larger PSFCH resource pool. For example, as illustrated in FIG. 12, a larger PSFCH resource pool 1202 may be configured that may span multiple RB sets, such as RB set 0 and RB set 1. In some cases, the larger PSFCH resource pool 1202 may be configured by an indication of the starting RB of the larger PSFCH resource pool 1202 as well as an indication of a number of RBs included within the larger PSFCH resource pool 1202. Thereafter, the PSFCH resource pools for RB set 0 and RB set 1 may be defined by removing resources (e.g., RBs) within the guard band 1204 disposed between RB set 0 and RB set 1. For example, by removing the RBs within the guard band 1204 from the larger PSFCH resource pool 1202, a first PSFCH resource pool 1206 may be defined for RB set 0 and a second PSFCH resource pool 1208 may be defined for RB set 1. As shown, the first PSFCH resource pool 1206 may be larger than the second PSFCH resource pool 1208.

Accordingly, in this case, when a larger PSFCH resource pool is configured, the first UE may determine the PSFCH resource pools for respective RB sets by first determining the larger PSFCH resource pool 1202 spanning the RB sets 0 and 1, which may be occupied by the second UE for a COT. In some cases, the first UE may determine the larger PSFCH resource pool 1202 based on an indication of a starting RB for the larger PSFCH resource pool 1202 and a number of RBs included within the larger PSFCH resource pool 1202. Thereafter, the first UE may determine the first PSFCH resource pool 1206 for RB set 0 and the second PSFCH resource pool 1208 for RB set 1 by removing RBs within the guard bands 1204 (e.g., disposed between RB set 0 and RB set 1) from the RBs included within the larger PSFCH resource pool 1202. Thereafter, the UE may transmit feedback information on resources in at least one of the first PSFCH resource pool 1206 or the second PSFCH resource pool 1208. In some cases, as noted above, the UE may make a determination of which of the first PSFCH resource pool 1206 or the second PSFCH resource pool 1208 to transmit the feedback information on based, for example, on PRI.

In some cases, the PSFCH resource pool may be dynamic and based on available RB sets. For example, in this case, a larger PSFCH resource pool may be configured that spans multiple RB sets and intra-cell guard bands. In this case, the actual PSFCH resource pool that may be used by the first UE for transmitting feedback information may be determined for each COT as a subset of the PSFCH resources from the larger PSFCH resource pool. In some cases, the actual PSFCH resource pool to use for transmitting the feedback information may be determined dynamically in different ways.

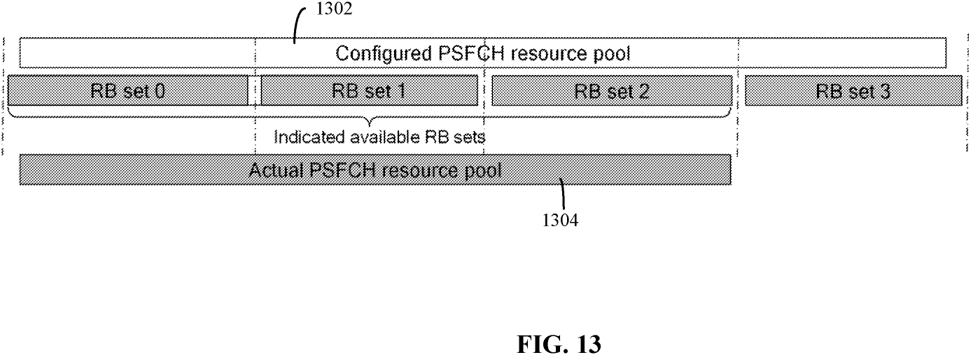

For example, in some cases, the actual PSFCH resource pool may be based on an available number of RB sets, as illustrated in FIG. 13. For example, as illustrated in FIG. 13, a larger PSFCH resource pool 1302 may be configured, spanning multiple RB sets and intra-cell guard bands, such as RB sets 0-3. Here, the actual PSFCH resource pool may be confined to the RB sets occupied by the second UE (e.g., and guard band in-between these RB sets). In this case, the second UE may provide an indication to the first UE of the RB sets that are available for the COT occupied by the second UE for carrying the feedback information on the PSFCH. In some cases, the RB set availability information may be provided in SCI (SCI1 or SCI2) transmitted by the second UE. Given the RB set availability information, the first UE may determine a sub-resource pool for PSFCH for this COT and use that sub-resource pool for PSFCH hashing.

For example, in some cases, the first UE may determine the configured larger PSFCH resource pool 1302 for transmitting feedback information. In some cases, configured larger PSFCH resource pool 1302 may be confined to at least the one or more RB sets and one or more guard bands between the one or more RB sets of the unlicensed spectrum occupied by the second UE for the COT. Thereafter, the first UE may receive information indicating one or more available RB sets of one or more RB sets occupied by the second UE for a COT. In some cases, as illustrated in FIG. 13, the information may indicate that RB sets 0-2 are available. In some cases, the first UE may receive the information indicating one or more available RB sets in sidelink control information from the second UE. Thereafter, the first UE may then determine, from the larger PSFCH resource pool 1302, a sub-resource pool 1304 for transmitting the feedback information on the feedback channel for the COT based on the information indicating the one or more available RB sets. For example, as illustrated, in this case, the sub-resource pool 1304 may span RB sets 0-2.

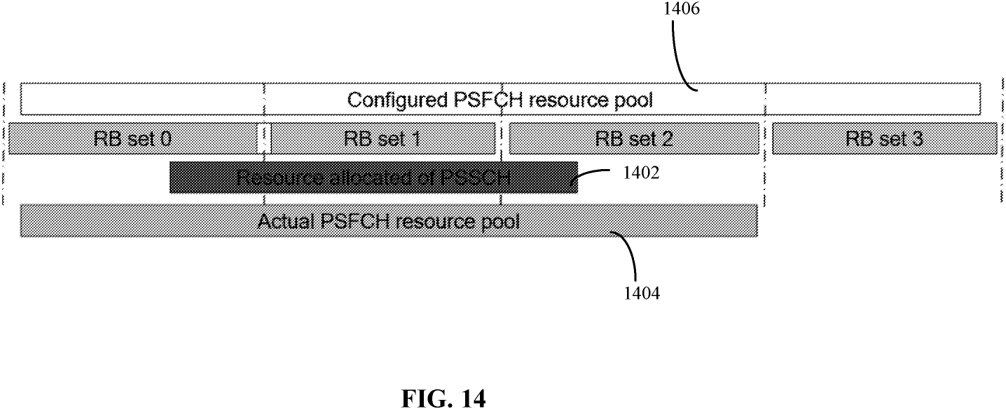

In some cases, the sub-resource pool for the PSFCH may be confined to the RB sets occupied by PSSCH (e.g., and guard band in-between these RB sets). For example, as illustrated in FIG. 14, a PSSCH 1402 may be transmitted by the second UE across multiple RB sets, such as RB sets 0-2. Accordingly, in this case, the sub-resource pool 1404 for PSFCH may be confined to the RB sets occupied by PSSCH (e.g., and guard band in-between these RB sets). For example, as illustrated, the sub-resource pool 1404 for PSFCH may be confined to RB sets 0-2 since the PSSCH is transmitted in RB sets 0-2. In some cases, second UE may provide the first UE with a PSSCH FDRA. Accordingly, combined with RB set definition, the first UE may be able to determine the set of RB sets that passed LBT at the second UE (e.g., the RB sets occupied by the second UE) and, given the occupied RB set information, the first UE may identify the sub-resource pool 1404 for PSFCH for this COT and use that sub-resource pool 1404 for PSFCH hashing.

For example, in some cases, the first UE may determine, from the one or more RB sets of the unlicensed spectrum occupied by the second UE for the COT, at least one RB set that includes resources allocated for the PSSCH. For example, in some cases, the first UE may determine that RB sets 0-2 may include resources allocated for the PSSCH 1402. Thereafter, the first UE may determine, from a configured larger resource pool 1406 spanning the RB sets 0-3, the sub-resource pool 1404 for transmitting feedback information on the feedback channel for the COT. In some cases, the first UE may determine the sub-resource pool 1404 based, at least in part, on the at least one RB set (e.g., RB sets 0-2) that include resources allocated the PSSCH 1402. Accordingly, as shown, in this case, the sub-resource pool 1404 may be confined to the at least one RB set (e.g., RB sets 0-2) that includes the resources allocated for the PSSCH 1402.

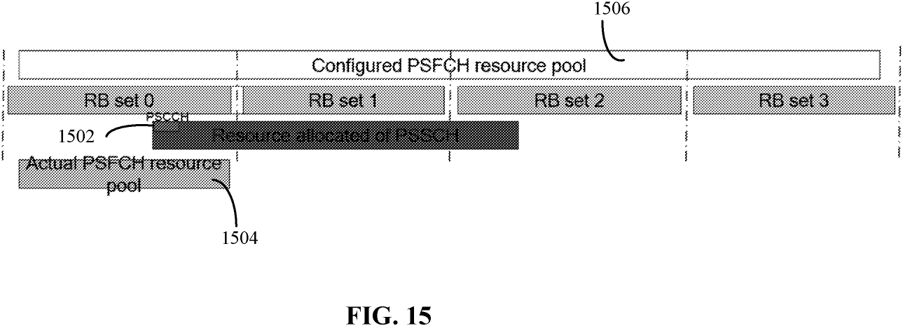

In some cases, the sub-resource pool for the PSFCH may be confined to the RB sets occupied by PSCCH. For example, as illustrated in FIG. 15, a PSCCH 1502 may be transmitted by the second UE in an RB set, such as RB set 0. Accordingly, in this case, the sub-resource pool 1504 for PSFCH may be confined to the RB set occupied by PSCCH. For example, as illustrated, the sub-resource pool 1504 for PSFCH may be confined to RB set 0 since the PSCCH is transmitted in RB set 0. Accordingly, the UE may receive the PSCCH in a sidelink sub-channel in RB set 0 occupied by the second UE for a COT and may determine the sub-resource pool for PSFCH for the COT and use that sub-resource pool for PSFCH hashing.

For example, in some cases, the first UE may determine, from the one or more RB sets of the unlicensed spectrum occupied by the second UE for the COT, at least one RB set that includes resources allocated for the PSCCH. For example, in some cases, the first UE may determine that RB set 0 may include resources allocated for the PSCCH 1502. Thereafter, the first UE may determine, from a configured larger resource pool 1506 spanning the RB sets 0-3, the sub-resource pool 1504 for transmitting feedback information on the feedback channel for the COT. In some cases, the first UE may determine the sub-resource pool 1504 based, at least in part, on the at least one RB set (e.g., RB set 0) that includes the resources allocated the PSCCH 1502. Accordingly, as shown, in this case, the sub-resource pool 1504 may be confined to the at least one RB set (e.g., RB set 0) that includes the resources allocated for the PSCCH 1502.

FIG. 16 is a flow diagram illustrating example operations 1600 for wireless communication, for example, for sidelink feedback channel resource mapping in unlicensed spectrum, in accordance with certain aspects of the present disclosure. The operations 1600 may be performed, for example, by a first UE (e.g., the UE 120a in the wireless communication network 100). The operations 1600 may be implemented as software components that are executed and run on one or more processors (e.g., controller/processor 280 of FIG. 2). Further, the transmission and reception of signals by the UE in operations 1600 may be enabled, for example, by one or more antennas (e.g., antennas 252 of FIG. 2). In certain aspects, the transmission and/or reception of signals by the UE may be implemented via a bus interface of one or more processors (e.g., controller/processor 280) obtaining and/or outputting signals.

The operations 1600 may begin, at block 1602, by receiving one or more transmissions from a second UE on one or more sidelink sub-channels spanning one or more resource block (RB) sets of an unlicensed spectrum occupied by the second UE for a channel occupancy time (COT).

Operations 1600 may continue, at block 1604, by transmitting, to the second UE, feedback information corresponding to the one or more received transmissions on a feedback channel based on a mapping between the one or more sidelink sub-channels and the feedback channel that confines the feedback channel to at least the one or more RB sets and one or more guard bands between the one or more RB sets of the unlicensed spectrum occupied by the second UE for the COT.

In some cases, the mapping defines a separate resource pool for the feedback channel for each RB set of the one or more RB sets occupied by the second UE.

In some cases, operations 1600 may further include receiving a physical resource indicator (PRI) from the second UE in a sidelink control information (SCI) granting the COT to the first UE and determining a resource pool for transmitting the feedback information on the feedback channel based on the PRI. In some cases, the one or more sidelink sub-channels comprise a sidelink control channel and the mapping confines the feedback channel to one or more RB sets occupied by the sidelink control channel.

In other cases, the one or more sidelink sub-channels comprise a sidelink shared channel and the mapping confines the feedback channel to one or more RB sets occupied by the side link shared channel. In some cases, the sidelink shared channel spans at least two RB sets of the one of more RB sets and the PRI indicates the resource pool of one RB set of the at least two RB sets to use for transmitting the feedback information on the feedback channel.

In some cases, the mapping confines the feedback channel to the one or more RB sets of the unlicensed spectrum occupied by the second UE.

Additionally, in some cases, operations 1600 may further include determining one or more resource pools for transmitting the feedback information on the feedback channel, wherein transmitting the feedback information is based on the determined one or more resource pools.

For example, in some cases, determining the one or more resource pools comprises determining a resource pool for each RB set of the one or more RB sets based, at least in part on an indication of a starting RB for the resource pool within that RB set and a number of RBs included within the resource pool within that RB set.

In some cases, determining the one or more resource pools may include determining a resource pool spanning the one or more RB sets occupied by the second UE for the COT based, at least in part on an indication of a starting RB for the resource pool and a number of RBs included within the resource pool. Additionally, in some cases, determining the resource pool spanning the one or more RB sets further comprises removing RBs within the one or more guard bands from the RBs included within the resource pool.

In some cases, operations 1600 may further include determining a configured resource pool for transmitting the feedback information on the feedback channel. In some cases, the configured resource pool is confined to at least the one or more RB sets and one or more guard bands between the one or more RB sets of the unlicensed spectrum occupied by the second UE for the COT.

Additionally, in some cases, operations 1600 may further include receiving information indicating one or more available RB sets of the one or more RB sets occupied by the second UE for the COT and determining, from the configured resource pool, a sub-resource pool for transmitting the feedback information on the feedback channel for the COT based on the information indicating the one or more available RB sets. In some cases, the information indicating one or more available RB sets of the one or more RB sets occupied by the second UE for the COT is received from the second UE in sidelink control information.

Additionally, in some cases, operations 1600 may further include determining, from the one or more RB sets of the unlicensed spectrum occupied by the second UE for the COT, at least one RB set that includes resources allocated for a sidelink shared channel. Additionally, in some cases, operations 1600 may further include determining, from the configured resource pool, a sub-resource pool for transmitting the feedback information on the feedback channel for the COT based, at least in part, on the at least one RB set that include resources allocated for a sidelink shared channel. In some case, the sub-resource pool may be confined to the at least one RB set that includes the resources allocated for a sidelink shared channel.

Additionally, in some cases, operations 1600 may further include determining, from the one or more RB sets of the unlicensed spectrum occupied by the second UE for the COT, at least one RB set that include resources allocated for a sidelink control channel. Additionally, in some cases, operations 1600 may further include determining, from the configured resource pool, a sub-resource pool for transmitting the feedback information on the feedback channel for the COT based, at least in part, on the at least one RB set that include resources allocated for a sidelink control channel. In some cases, the sub-resource pool may be confined to the at least one RB set that includes the resources allocated for a sidelink control channel.

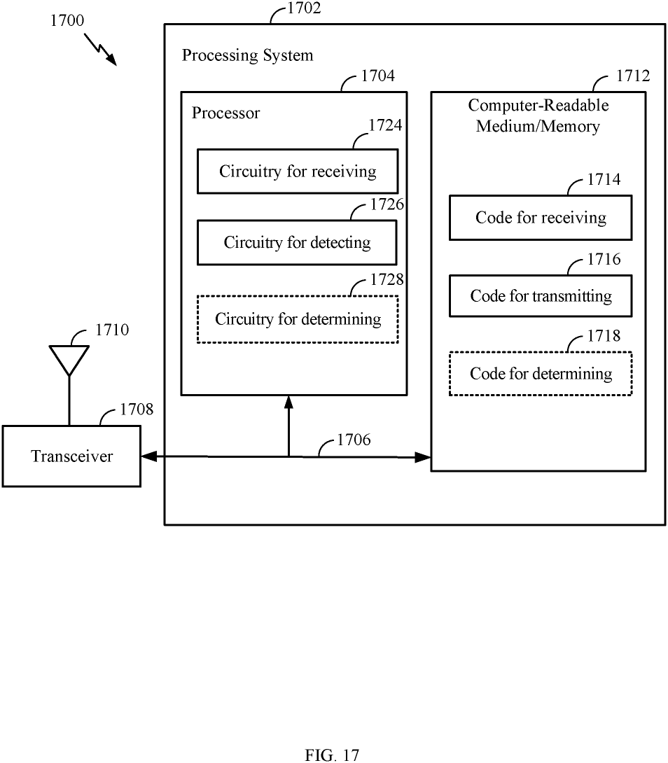

FIG. 17 illustrates a communications device 1700 that may include various components (e.g., corresponding to means-plus-function components) configured to perform operations for the techniques disclosed herein, such as the operations illustrated in FIG. 16. The communications device 1700 includes a processing system 1702 coupled to a transceiver 1708 (e.g., a transmitter and/or a receiver). The transceiver 1708 is configured to transmit and receive signals for the communications device 1700 via an antenna 1710, such as the various signals as described herein. The processing system 1702 may be configured to perform processing functions for the communications device 1700, including processing signals received and/or to be transmitted by the communications device 1700.

The processing system 1702 includes a processor 1704 coupled to a computer-readable medium/memory 1712 via a bus 1706. In certain aspects, the computer-readable medium/memory 1712 is configured to store instructions (e.g., computer-executable code) that when executed by the processor 1704, cause the processor 1704 to perform the operations illustrated in FIG. 16, or other operations for performing the various techniques discussed herein for sidelink feedback channel resource mapping in unlicensed spectrum. In certain aspects, computer-readable medium/memory 1712 stores code 1714 for receiving, code 1716 for transmitting, and code 1718 for determining.

In some cases, the code 1714 for receiving may include code for receiving one or more transmissions from a second UE on one or more sidelink sub-channels spanning one or more resource block (RB) sets of an unlicensed spectrum occupied by the second UE for a channel occupancy time (COT).

In some cases, the code 1716 for transmitting may include code for transmitting, to the second UE, feedback information corresponding to the one or more received transmissions on a feedback channel based on a mapping between the one or more sidelink sub-channels and the feedback channel that confines the feedback channel to at least the one or more RB sets and one or more guard bands between the one or more RB sets of the unlicensed spectrum occupied by the second UE for the COT.

In some cases, the code 1714 for receiving may include code for receiving a physical resource indicator (PRI) from the second UE in a sidelink control information (SCI) granting the COT to the first UE.

In some cases, the code 1718 for determining may include code for determining a resource pool for transmitting the feedback information on the feedback channel based on the PRI.

In some cases, the code 1718 for determining may include code for determining one or more resource pools for transmitting the feedback information on the feedback channel, wherein transmitting the feedback information is based on the determined one or more resource pools.

In some cases, the code 1718 for determining may include code for determining a resource pool for each RB set of the one or more RB sets based, at least in part on an indication of a starting RB for the resource pool within that RB set and a number of RBs included within the resource pool within that RB set.

In some cases, the code 1718 for determining may include code for determining the one or more resource pools comprises determining a resource pool spanning the one or more RB sets occupied by the second UE for the COT based, at least in part on: an indication of a starting RB for the resource pool and a number of RBs included within the resource pool. Additionally, in some cases, the code 1718 for determining may include code for removing RBs within the one or more guard bands from the RBs included within the resource pool.

In some cases, the code 1718 for determining may include code for determining a configured resource pool for transmitting the feedback information on the feedback channel, wherein the configured resource pool is confined to at least the one or more RB sets and one or more guard bands between the one or more RB sets of the unlicensed spectrum occupied by the second UE for the COT.

In some cases, the code 1714 for receiving may include code for receiving information indicating one or more available RB sets of the one or more RB sets occupied by the second UE for the COT. Additionally, in some cases, the code 1718 for determining may include code for determining, from the configured resource pool, a sub-resource pool for transmitting the feedback information on the feedback channel for the COT based on the information indicating the one or more available RB sets.

Additionally, in some cases, the code 1718 for determining may include code for determining, from the one or more RB sets of the unlicensed spectrum occupied by the second UE for the COT, at least one RB set that includes resources allocated for a sidelink shared channel; and

Additionally, in some cases, the code 1718 for determining may include code for determining, from the configured resource pool, a sub-resource pool for transmitting the feedback information on the feedback channel for the COT based, at least in part, on the at least one RB set that include resources allocated for a sidelink shared channel, wherein the sub-resource pool is confined to the at least one RB set that includes the resources allocated for a sidelink shared channel.

Additionally, in some cases, the code 1718 for determining may include code for determining, from the one or more RB sets of the unlicensed spectrum occupied by the second UE for the COT, at least one RB set that include resources allocated for a sidelink control channel; and

Additionally, in some cases, the code 1718 for determining may include code for determining, from the configured resource pool, a sub-resource pool for transmitting the feedback information on the feedback channel for the COT based, at least in part, on the at least one RB set that include resources allocated for a sidelink control channel, wherein the sub-resource pool is confined to the at least one RB set that includes the resources allocated for a sidelink control channel.

In certain aspects, the processor 1704 may include circuitry configured to implement the code stored in the computer-readable medium/memory 1712, such as for performing the operations illustrated in FIG. 16, or other operations for performing the various techniques discussed herein for sidelink feedback channel resource mapping in unlicensed spectrum. For example, the processor 1704 includes circuitry 1724 for receiving, circuitry 1726 for transmitting, and circuitry 1728 for determining.

In some cases, the circuitry 1724 for receiving may include circuitry for receiving one or more transmissions from a second UE on one or more sidelink sub-channels spanning one or more resource block (RB) sets of an unlicensed spectrum occupied by the second UE for a channel occupancy time (COT).

In some cases, the circuitry 1726 for transmitting may include circuitry for transmitting, to the second UE, feedback information corresponding to the one or more received transmissions on a feedback channel based on a mapping between the one or more sidelink sub-channels and the feedback channel that confines the feedback channel to at least the one or more RB sets and one or more guard bands between the one or more RB sets of the unlicensed spectrum occupied by the second UE for the COT.

In some cases, the circuitry 1724 for receiving may include circuitry for receiving a physical resource indicator (PRI) from the second UE in a sidelink control information (SCI) granting the COT to the first UE.

In some cases, the circuitry 1728 for determining may include circuitry for determining a resource pool for transmitting the feedback information on the feedback channel based on the PRI.

In some cases, the circuitry 1728 for determining may include circuitry for determining one or more resource pools for transmitting the feedback information on the feedback channel, wherein transmitting the feedback information is based on the determined one or more resource pools.

In some cases, the circuitry 1728 for determining may include circuitry for determining a resource pool for each RB set of the one or more RB sets based, at least in part on an indication of a starting RB for the resource pool within that RB set and a number of RBs included within the resource pool within that RB set.

In some cases, the circuitry 1728 for determining may include circuitry for determining the one or more resource pools comprises determining a resource pool spanning the one or more RB sets occupied by the second UE for the COT based, at least in part on: an indication of a starting RB for the resource pool and a number of RBs included within the resource pool. Additionally, in some cases, the circuitry 1728 for determining may include circuitry for removing RBs within the one or more guard bands from the RBs included within the resource pool.

In some cases, the circuitry 1728 for determining may include circuitry for determining a configured resource pool for transmitting the feedback information on the feedback channel, wherein the configured resource pool is confined to at least the one or more RB sets and one or more guard bands between the one or more RB sets of the unlicensed spectrum occupied by the second UE for the COT.

In some cases, the circuitry 1724 for receiving may include circuitry for receiving information indicating one or more available RB sets of the one or more RB sets occupied by the second UE for the COT. Additionally, in some cases, the circuitry 1728 for determining may include circuitry for determining, from the configured resource pool, a sub-resource pool for transmitting the feedback information on the feedback channel for the COT based on the information indicating the one or more available RB sets.

Additionally, in some cases, the circuitry 1728 for determining may include circuitry for determining, from the one or more RB sets of the unlicensed spectrum occupied by the second UE for the COT, at least one RB set that includes resources allocated for a sidelink shared channel; and

Additionally, in some cases, the circuitry 1728 for determining may include circuitry for determining, from the configured resource pool, a sub-resource pool for transmitting the feedback information on the feedback channel for the COT based, at least in part, on the at least one RB set that include resources allocated for a sidelink shared channel, wherein the sub-resource pool is confined to the at least one RB set that includes the resources allocated for a sidelink shared channel.

Additionally, in some cases, the circuitry 1728 for determining may include circuitry for determining, from the one or more RB sets of the unlicensed spectrum occupied by the second UE for the COT, at least one RB set that include resources allocated for a sidelink control channel; and

Additionally, in some cases, the circuitry 1728 for determining may include circuitry for determining, from the configured resource pool, a sub-resource pool for transmitting the feedback information on the feedback channel for the COT based, at least in part, on the at least one RB set that include resources allocated for a sidelink control channel, wherein the sub-resource pool is confined to the at least one RB set that includes the resources allocated for a sidelink control channel.

### Example Aspects

Aspect 1: A method of wireless communication by a first user equipment (UE), comprising: receiving one or more transmissions from a second UE on one or more sidelink sub-channels spanning one or more resource block (RB) sets of an unlicensed spectrum occupied by the second UE for a channel occupancy time (COT) and transmitting, to the second UE, feedback information corresponding to the one or more received transmissions on a feedback channel based on a mapping between the one or more sidelink sub-channels and the feedback channel that confines the feedback channel to at least the one or more RB sets and one or more guard bands between the one or more RB sets of the unlicensed spectrum occupied by the second UE for the COT.

Aspect 2: The method of Aspect 1, wherein the mapping defines a separate resource pool for the feedback channel for each RB set of the one or more RB sets occupied by the second UE.

Aspect 3: The method of one or more of Aspect 1 or Aspect 2, further comprising receiving a physical resource indicator (PRI) from the second UE in a sidelink control information (SCI) granting the COT to the first UE and determining a resource pool for transmitting the feedback information on the feedback channel based on the PRI.

Aspect 4: The method of Aspect 3, wherein the one or more sidelink sub-channels comprise a sidelink control channel and the mapping confines the feedback channel to one or more RB sets occupied by the sidelink control channel.

Aspect 5: The method of Aspect 3, wherein the one or more sidelink sub-channels comprise a sidelink shared channel and the mapping confines the feedback channel to one or more RB sets occupied by the side link shared channel.

Aspect 6: The method of Aspect 5, wherein the sidelink shared channel spans at least two RB sets of the one of more RB sets and the PRI indicates the resource pool of one RB set of the at least two RB sets to use for transmitting the feedback information on the feedback channel.

Aspect 7: The method of any of Aspects 1-6, wherein the mapping confines the feedback channel to the one or more RB sets of the unlicensed spectrum occupied by the second UE.

Aspect 8: The method of any of Aspects 1-7, further comprising determining one or more resource pools for transmitting the feedback information on the feedback channel, wherein transmitting the feedback information is based on the determined one or more resource pools.

Aspect 9: The method of Aspect 8, wherein determining the one or more resource pools comprises determining a resource pool for each RB set of the one or more RB sets based, at least in part on: an indication of a starting RB for the resource pool within that RB set and a number of RBs included within the resource pool within that RB set.

Aspect 10: The method of Aspect 8, wherein determining the one or more resource pools comprises determining a resource pool spanning the one or more RB sets occupied by the second UE for the COT based, at least in part on: an indication of a starting RB for the resource pool and a number of RBs included within the resource pool.

Aspect 11: The method of Aspect 10, wherein determining the resource pool spanning the one or more RB sets further comprises removing RBs within the one or more guard bands from the RBs included within the resource pool.

Aspect 12: The method of any of Aspects 1-11, further comprising determining a configured resource pool for transmitting the feedback information on the feedback channel, wherein the configured resource pool is confined to at least the one or more RB sets and one or more guard bands between the one or more RB sets of the unlicensed spectrum occupied by the second UE for the COT.

Aspect 13: The method of Aspect 12, further comprising receiving information indicating one or more available RB sets of the one or more RB sets occupied by the second UE for the COT and determining, from the configured resource pool, a sub-resource pool for transmitting the feedback information on the feedback channel for the COT based on the information indicating the one or more available RB sets.

Aspect 14: The method of Aspect 13, wherein the information indicating one or more available RB sets of the one or more RB sets occupied by the second UE for the COT is received from the second UE in sidelink control information.

Aspect 15: The method of Aspect 12, further comprising determining, from the one or more RB sets of the unlicensed spectrum occupied by the second UE for the COT, at least one RB set that includes resources allocated for a sidelink shared channel and determining, from the configured resource pool, a sub-resource pool for transmitting the feedback information on the feedback channel for the COT based, at least in part, on the at least one RB set that include resources allocated for a sidelink shared channel, wherein the sub-resource pool is confined to the at least one RB set that includes the resources allocated for a sidelink shared channel.

Aspect 16: The method of Aspect 12, further comprising determining, from the one or more RB sets of the unlicensed spectrum occupied by the second UE for the COT, at least one RB set that include resources allocated for a sidelink control channel and determining, from the configured resource pool, a sub-resource pool for transmitting the feedback information on the feedback channel for the COT based, at least in part, on the at least one RB set that include resources allocated for a sidelink control channel, wherein the sub-resource pool is confined to the at least one RB set that includes the resources allocated for a sidelink control channel.

### Additional Considerations

The techniques described herein may be used for various wireless communication technologies, such as NR (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

In 3GPP, the term “cell” can refer to a coverage area of a Node B (NB) and/or a NB subsystem serving this coverage area, depending on the context in which the term is used. In NR systems, the term “cell” and BS, next generation NodeB (gNB or gNodeB), access point (AP), distributed unit (DU), carrier, or transmission reception point (TRP) may be used interchangeably. A BS may provide communication coverage for a macro cell, a pico cell, a femto cell, and/or other types of cells. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG), UEs for users in the home, etc.). A BS for a macro cell may be referred to as a macro BS. A BS for a pico cell may be referred to as a pico BS. A BS for a femto cell may be referred to as a femto BS or a home BS.

A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, which may be narrowband IoT (NB-IoT) devices.

In some examples, access to the air interface may be scheduled. A scheduling entity (e.g., a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer- readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein, for example, instructions for performing the operations described herein and illustrated in FIG. 16 and/or other operations described herein for transmitting feedback information on a sidelink feedback channel in an unlicensed spectrum according to a sidelink feedback channel resource mapping.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. A method for wireless communication by a first user equipment (UE), comprising:
receiving one or more transmissions from a second UE on one or more sidelink sub-channels spanning one or more resource block (RB) sets of an unlicensed spectrum occupied by the second UE for a channel occupancy time (COT); and
transmitting, to the second UE, feedback information corresponding to the one or more received transmissions on a feedback channel based on a mapping between the one or more sidelink sub-channels and the feedback channel that confines the feedback channel to at least the one or more RB sets and one or more guard bands between the one or more RB sets of the unlicensed spectrum occupied by the second UE for the COT.

2. The method of claim 1, wherein the mapping defines a separate resource pool for the feedback channel for each RB set of the one or more RB sets occupied by the second UE.

3. The method of claim 1, further comprising:
receiving a physical resource indicator (PRI) from the second UE in a sidelink control information (SCI) granting the COT to the first UE; and
determining a resource pool for transmitting the feedback information on the feedback channel based on the PRI.

4. The method of claim 3, wherein:
the one or more sidelink sub-channels comprise a sidelink control channel; and
the mapping confines the feedback channel to one or more RB sets occupied by the sidelink control channel.

5. The method of claim 3, wherein:
the one or more sidelink sub-channels comprise a sidelink shared channel; and
the mapping confines the feedback channel to one or more RB sets occupied by the sidelink shared channel.

6. The method of claim 5, wherein:
the sidelink shared channel spans at least two RB sets of the one of more RB sets; and
the PRI indicates the resource pool of one RB set of the at least two RB sets to use for transmitting the feedback information on the feedback channel.

7. The method of claim 1, wherein the mapping confines the feedback channel to the one or more RB sets of the unlicensed spectrum occupied by the second UE.

8. The method of claim 1, further comprising determining one or more resource pools for transmitting the feedback information on the feedback channel, wherein transmitting the feedback information is based on the determined one or more resource pools.

9. The method of claim 8, wherein determining the one or more resource pools comprises determining a resource pool for each RB set of the one or more RB sets based, at least in part on:
an indication of a starting RB for the resource pool within that RB set; and
a number of RBs included within the resource pool within that RB set.

10. The method of claim 8, wherein determining the one or more resource pools comprises determining a resource pool spanning the one or more RB sets occupied by the second UE for the COT based, at least in part on:
an indication of a starting RB for the resource pool; and
a number of RBs included within the resource pool.

11. The method of claim 10, wherein determining the resource pool spanning the one or more RB sets further comprises removing RBs within the one or more guard bands from the RBs included within the resource pool.

12. The method of claim 1, further comprising determining a configured resource pool for transmitting the feedback information on the feedback channel, wherein the configured resource pool is confined to at least the one or more RB sets and one or more guard bands between the one or more RB sets of the unlicensed spectrum occupied by the second UE for the COT.

13. The method of claim 12, further comprising:
receiving information indicating one or more available RB sets of the one or more RB sets occupied by the second UE for the COT; and
determining, from the configured resource pool, a sub-resource pool for transmitting the feedback information on the feedback channel for the COT based on the information indicating the one or more available RB sets.

14. The method of claim 13, wherein the information indicating one or more available RB sets of the one or more RB sets occupied by the second UE for the COT is received from the second UE in sidelink control information.

15. The method of claim 12, further comprising:
determining, from the one or more RB sets of the unlicensed spectrum occupied by the second UE for the COT, at least one RB set that includes resources allocated for a sidelink shared channel; and
determining, from the configured resource pool, a sub-resource pool for transmitting the feedback information on the feedback channel for the COT based, at least in part, on the at least one RB set that include resources allocated for a sidelink shared channel, wherein the sub-resource pool is confined to the at least one RB set that includes the resources allocated for a sidelink shared channel.

16. The method of claim 12, further comprising:
determining, from the one or more RB sets of the unlicensed spectrum occupied by the second UE for the COT, at least one RB set that include resources allocated for a sidelink control channel; and
determining, from the configured resource pool, a sub-resource pool for transmitting the feedback information on the feedback channel for the COT based, at least in part, on the at least one RB set that include resources allocated for a sidelink control channel, wherein the sub-resource pool is confined to the at least one RB set that includes the resources allocated for a sidelink control channel.

17. A first user equipment (UE) for wireless communications, comprising:
means for receiving one or more transmissions from a second UE on one or more sidelink sub-channels spanning one or more resource block (RB) sets of an unlicensed spectrum occupied by the second UE for a channel occupancy time (COT); and
means for transmitting, to the second UE, feedback information corresponding to the one or more received transmissions on a feedback channel based on a mapping between the one or more sidelink sub-channels and the feedback channel that confines the feedback channel to at least the one or more RB sets and one or more guard bands between the one or more RB sets of the unlicensed spectrum occupied by the second UE for the COT.

18. A first user equipment (UE) for wireless communications, comprising:
a memory; and
a processor coupled to the memory, the memory and the processor configured to: .
receive one or more transmissions from a second UE on one or more sidelink sub-channels spanning one or more resource block (RB) sets of an unlicensed spectrum occupied by the second UE for a channel occupancy time (COT); and
transmit, to the second UE, feedback information corresponding to the one or more received transmissions on a feedback channel based on a mapping between the one or more sidelink sub-channels and the feedback channel that confines the feedback channel to at least the one or more RB sets and one or more guard bands between the one or more RB sets of the unlicensed spectrum occupied by the second UE for the COT.

19. A computer-readable medium, the medium including instructions that, when executed by at least one processor of a first user equipment (UE), cause the at least one processor:
receive one or more transmissions from a second UE on one or more sidelink sub-channels spanning one or more resource block (RB) sets of an unlicensed spectrum occupied by the second UE for a channel occupancy time (COT); and
transmit, to the second UE, feedback information corresponding to the one or more received transmissions on a feedback channel based on a mapping between the one or more sidelink sub-channels and the feedback channel that confines the feedback channel to at least the one or more RB sets and one or more guard bands between the one or more RB sets of the unlicensed spectrum occupied by the second UE for the COT.
